(19) United States
(12) Patent Application Publication
(10) Pub. No.: US 2022/0327454 A1
(43) Pub. Date: Oct. 13, 2022

(54) Method and system for generating and using value functions for users

(71) Applicant: PACTUM AI OÜ, Maardu (EE)

(72) Inventors: Martin Rand, Tallinn (EE); Kristjan Korjus, Tallinn (EE); Kaspar Korjus, Maardu (EE)

(21) Appl. No.: 17/641,042

(22) PCT Filed: Sep. 7, 2020
(86) PCT No.: PCT/EP2020/074967

§ 371 Date: Mar. 7, 2022

(30) Foreign Application Priority Data
Sep. 9, 2019 (EP) 19196220.8

(51) Int. Cl. G06Q 10/06; G06Q 10/04

(52) U.S. Cl. CPC G06Q 10/06375; G06Q 10/04; G06Q 50/188

(57) ABSTRACT

Methods for generating and using a value function include inputting at least one variable parameter, inputting at least one environmental parameter, defining a relationship between the at least one input variable parameter and the at least one input environmental parameter, and generating a value function based on the input parameters and the defined relationship, the value function returning a real number. Systems for generating and using a value function include a variable parameter database including variable parameters, an environmental parameter database including environmental parameters, a processing component configured to receive at least one variable parameter from the variable parameter database; receive at least one environmental parameter from the environmental parameter database; define a relationship between the at least one input variable parameter and the at least one input environmental parameter; and generate a value function based on the input parameters and the defined relationship, the value function returning a real number.

### FIELD

The invention relates to generation and usage of value functions related to users. More specifically, the invention relates to virtual negotiations and contract management based on value functions.

### INTRODUCTION

Companies, government organizations and other legal entities generally base their decisions on a system of values that reflect their priorities and goals. This value system may not be explicitly defined, but often governs transactions and relationships that such entities build and maintain. Understanding and quantifying the value systems of various entities allows for large scale streamlining of processes and overall minimization of resource use.

One large aspect of various entities' functioning is negotiating and entering into contracts with their partners or third parties. Such contracts can be based on many factors such as the parties involved, geopolitical factors, economic factors and the like. Contract negotiation is often based on value systems of the negotiating parties. Automating contract negotiation and management is clearly advantageous, but technically difficult due to the many factors contributing to the interests of both parties, the use of natural language and the limited information available to each party during the negotiation.

Automatic contract negotiation has been disclosed in some of the state of the art.

For example, United States' patent application 2014/0164255 A1 discloses a system and method for enabling coordinated, collaborative, data-driven document negotiation among multiple, divergent parties, either internally or externally, in a virtual environment. The system streamlines and automates coordination of the life cycle of a binding document from deal origination to collaborative negotiation to executed agreement to archival to system-generated analytics. A term-based engine replaces the manual business and legal processes, and streamlines management of communication, approvals, signatures, commenting, recordkeeping and documentation.

Also, U.S. Pat. No. 9,514,499 B1 discloses methods, computer program products, and systems for a predictive approach to contract management. In one embodiment, acceptable contract parameters are predicted based, at least in part on historic data and specified thresholds of identified contract parameters. Predicting acceptable contract parameters can help reduce negotiation cycles.

International patent application WO 2017/173399 A1 discloses a system and method that includes providing a contract management platform; constructing a data-driven contract with a set of programmable clauses by: receiving specification of a programmable clause, configuring programmable logic of the programmable clauses, mapping a set of integrations to the programmable clause, wherein at least one integration is a blockchain/distributed ledger integration, and adding at least one clause with natural language content; and executing the data-driven contract.

Further, US patent application 2019/0026848 A1 discloses systems and methods that provide a user-friendly, automated and transparent, contract drafting and negotiation tool. Through the contract drafting and negotiation tool two parties can negotiate agreement using template agreements including one or more sections in which each user is able to select one of a plurality of input options that affect the terms of the contract. In each instance, each party can see the option selected by the other party, as well as the options not selected by the other party. The systems and methods facilitate efficient and transparent contract negotiation and drafting.

Although some methods of automatic negotiation are known in the art, they are not generally based on the underlying value system of the parties. This, however, can be very important for automatically conducting negotiations or automatically generating contracts on behalf of a user.

### SUMMARY

It is the object of the present invention to provide an improved and reliable way of generating a value function for a user. It is also the object of the present invention to disclose ways of using the value function, preferably for automatic negotiations.

In a first embodiment, a method for generating and using a value function for a user is disclosed. The method comprises inputting at least one variable parameter. The method further comprises inputting at least one environmental parameter. The method also comprises defining a relationship between the at least one input variable parameter and the at least one input environmental parameter. The method further comprises generating a value function based at least in part on the input parameters and the defined relationship, the value function returning a real number.

The present method advantageously allows to assess and quantitatively represent a user's value alignment. The user may comprise a company, an organisation, and/or an individual. It can be particularly useful to assign concrete rules and measurable parameters to a set of values and guidance principles. In a concrete example, the value function may comprise data related to negotiations and agreements, such as contract negotiations.

The variable parameters may comprise quantities that can be modified and are negotiable. For example, the variable parameters may comprise quantities such as “salary”, “percentage of revenue given as part of a license fee”, “exclusive/non-exclusive rights to a product” or the like.

The environmental parameters may comprise fixed or non-negotiable quantities. Those can relate to the user itself (e.g. current/historical quantities such as “yearly regional revenue”, “number of contract partners in a city” or the like), to a user's partners or third parties (e.g. “revenue of each of the regional partners”, “hourly rates of drivers employed by a given partner in a municipality” or the like), and/or auxiliary data such as market situation (e.g. “currency exchange rate”, “change in the consumer price index” or the like).

A relationship between the input parameters may represent a functional dependency between two or more parameters, a constraint linking two or more parameters or the like. The relationship may be defined between two or more variable parameters, two or more environmental parameters, and/or one or more variable parameter and one or more environmental parameter.

The value function may comprise a plurality of inputs some of which may be numerical, and some that may not be. However, the value function advantageously outputs or returns a real number. In this way, it is possible to immediately compare different outputs of the value function based on the e.g. different variable parameters. As the output of the value function reflects overall advantage or usefulness for the user, it is possible to immediately determine which input parameters, and, particularly variable parameters optimize the value function.

In some embodiments, the value function can be generated at least in part by combining the plurality of input parameters. Combining may refer to assigning a plurality of relationships, dependencies or the like. The value function preferably takes a plurality of inputs.

In some embodiments, the value function can be generated at least in part by assigning dependencies to the input parameters. Dependencies may reflect functional relationships between the input parameters and may allow to map vague value statements onto concrete outcomes.

In some embodiments, the value function can be generated at least in part by creating a flowchart comprising steps for verifying the plurality of input parameters. That is, the value function may comprise an algorithm that runs through the input parameters and, based on certain predefined conditions, controls their definition and relationships between them.

In some embodiments, the value function can be generated at least in part by converting the plurality of input parameters into quantitative parameters. That is, conditional statements or estimates can be converted into numbers. For example, this can be done by using natural language processing. Additionally or alternatively, this can also be done by posing a plurality of questions regarding the input parameters to the user, the questions designed to capture true value of input parameters. In other words, the questions may be progressively rephrased to arrive at a quantitative estimate of a parameter that was previously qualitatively estimated.

In some embodiments, the value function can be generated at least in part by applying a series of constraints to the input parameters.

In some embodiments, the method can further comprise inputting auxiliary supporting data prior to generating the value function. The auxiliary supporting data may be part of the environmental parameters and/or be an additional input for the value function. The auxiliary data may comprise generally known quantities and rules applying in a region and/or a given situation. In some such embodiments, the method can further comprise converting auxiliary supporting data into at least one of a numerical input parameter and a constraint.

In some embodiments, the method can further comprise updating the generated value function based on at least one of new input parameter and new auxiliary supporting data. That is, the value function may be advantageously kept up to date by regular updates.

In some embodiments, the method can further comprise forecasting time development of the generated value function by analysing at least one of the environmental parameters. That is, a future development of the value function can be forecasted. This can be done, for example, by analysing historical data forming part of the environmental parameters. For example, salary increases may be forecasted based on historical trends, and the future value function estimated based on the forecast.

In some embodiments, the method can further comprise, in response to receiving user feedback, updating the generated value function by modifying at least one relationship between the at least one variable parameter and environmental parameter. That is, the value function can be quality-controlled by the user, and can be further customized based on user feedback. This can advantageously allow for closer value alignment and a better quantitative representation of the user's interests.

In some embodiments, the method can further comprise using at least one of the variable parameters to generate a virtual template for a user. The virtual template may represent an agreement or contract template comprising several variable parameters that may be agreed upon as part of the negotiation. The virtual template may be stored in a database. There may be a plurality of virtual templates generated for one user, each corresponding to a particular desired contract and/or agreement. The virtual template preferably comprises some or all of the variable parameters that are input to the value function. In this way, the virtual template is linked to the value function via the variable parameters.

In some such embodiments, the virtual template can comprise at least one of the variable parameters and at least one descriptive variable. The descriptive variable can comprise, for example, names and addresses of the parties to the virtual template (to be filled when the need arises). The descriptive variables do not form part of the value function and serve only as auxiliary variables in the virtual template.

In some such embodiments, the method can further comprise evaluating the value function based on the filled variable parameters of the virtual template. In other words, when the virtual template is “filled” (that is, when variable parameters forming part of the virtual template assume a set value and/or are fixed as part of an agreement), the set values of the variable parameters may be input into the value function, and the “value” of the filled virtual template may be determined. This value may then be evaluated and compared with e.g. some other values resulting from differently filled virtual templates (e.g. existing other agreements/contracts and/or expected value of a particular filled virtual template). In this way, it can be determined whether the filled virtual template results in an advantageous agreement/contract for the user.

In some such embodiments, the method can further comprise comparing a plurality of filled virtual templates by evaluating the value function based on the filled variable parameters of each virtual template. As mentioned above, different filled virtual templates may correspond to different overall value or advantage to the user. These can be easily obtained by means of comparing the value functions based on the respective filled variable parameters of the filled virtual templates.

In some such embodiments, the method can further comprise using at least one of the environmental parameters to generate the virtual template and evaluating the value function based on the filled environmental parameters of the virtual template. The environmental parameters used to build the virtual template may correspond to those that are particularly relevant to a given situation. E.g. they may correspond to known data about a third party with whom the virtual template is to be used. Additionally or alternatively, the environmental parameters may correspond to regional characteristics such as local inflation or the like.

In some embodiments, the method can further comprise using the generated value function to conduct a virtual negotiation. The value function may serve as a “backbone” or foundation of the negotiation. Since the value function quantitatively represents the interests and values of a user, the course of the negotiation can be determined by evaluating possible outcomes against the value function and selecting the most favorable one. The evaluation may be performed iteratively during the negotiation.

In some embodiments, the method can further comprise communicating with a third party on behalf of the user. That is, the third party may enter the negotiation (e.g. via a negotiation interface) where a processing component or the like may conduct the negotiation with the third party without the user having to do it. Each input of the third party can be measured against the value function to estimate its influence on the resulting output/return of the value function. This can advantageously allow to estimate consequences of certain agreement or contract terms that the third party may request on the user's operations and business. The third party may comprise a company, an organization, an individual and/or the like. The third party may communicate on their own and/or similarly via an intermediary such as third party processing component (such as a third party server) that can communicate on the behalf of the third party.

In some embodiments, the method can further comprise receiving third party inputs and estimating a third party value function based on them. That is, the third party inputs may be used to “guess” or estimate the underlying value function guiding the third party. This third party value function is a priori not known, since the third party may not disclose all of the information necessary to build a complete value function. However, estimating the third party value function may advantageously allow to better understand the position and interests of the given third party, and thereby arrive to a mutually advantageous end of the negotiation.

In some such embodiments, the method can further comprise iteratively updating the estimated third party value function based on further third party inputs. In other words, each further input of the third party may lead to a slightly more precise and/or different estimation of the underlying third party value function. In this way, better understanding of the mutual benefits can be possible.

In some such embodiments, the method can further comprise simultaneously optimizing against the generated value function and the estimated third party value function. That is, the user and the third party may end up with a mutually beneficial result of the negotiation based on the generated (user) value function and the estimated third party value function.

In some such embodiments, the simultaneous optimization can comprise optimization of a plurality of variable parameters associated with each of the two value functions. That is, the variable parameters may be modified in such a way that both the outcome of the generated (user) value function and the estimated third party value function are simultaneously maximized. In this way, the overall result of the negotiation may advantageously result in a Pareto optimal state, thereby ensuring that both parties' interests have been simultaneously optimized. Since the variable parameters agreed upon would enter both value functions, modifying them allows to observe the effect on the output/return of both value functions.

In some embodiments, the method can further comprise automatically triggering the virtual negotiation based on a predetermined threshold. That is, the negotiation may be automatically proposed to the third party when a certain criterion is fulfilled. For example, if a certain amount of time elapsed since the last negotiation and/or if a certain parameter (e.g. inflation) reached a certain predetermined value, the negotiation may be triggered.

In some embodiments, the method can further comprise building up a virtual negotiation by selecting predetermined negotiation submodules. The negotiation submodules may comprise blocks or parts of the negotiation flowchart with certain topics/variable parameters being negotiated. Depending on the type of the negotiation, different submodules may be needed for different negotiations. In some such embodiments, the selection can be performed by evaluating a third party input in the virtual negotiation against the generated value function.

In some embodiments where the virtual template is generated, the method can further comprise filling out the virtual template during the virtual negotiation. In other words, the virtual negotiation may concern the filling out of a virtual template, such as a contract negotiation resulting in a new filled contract.

In some such embodiments, the virtual template can be filled based on third party input in the virtual negotiation evaluated against the generated value function. That is, the various variable parameters may be agreed upon during the negotiation and subsequently filled into the virtual contract.

Conducting virtual negotiations based on optimizing value functions can be generally beneficial for optimizing agreement/contract negotiations for users such as companies. It can be particularly advantageous to reduce the resources (monetary, time-based or the like) and ensure that an optimal agreement is achieved. Automating such negotiation processes by using artificial intelligence can ensure impartial and fair negotiation process and a result that may be significantly improved as compared to negotiations conducted by humans. With the backbone of quantifiable value alignment tailored to the user, the virtual negotiations can lead to improved outcomes in contract/agreement negotiations.

In some embodiments, the method can further comprise filling out a virtual template associated with the user and a third party based at least in part on the generated value function. The virtual template may correspond to a contract and/or an agreement as detailed above. The virtual template can be filled automatically. The virtual template can be user-dependent and/or third party dependent. In other words, different templates may be selected for different users and/or different third parties that the user may be negotiating with.

In some embodiments, the virtual template can be filled out at least in part based on third party inputs. In some such embodiments, the method can further comprise receiving third party inputs and processing them to generate outputs transmitted to the third party. In some such embodiments, the method can further comprise comparing third party inputs to the generated value function, and, based on the comparison, generating outputs transmitted to the third party. In some such embodiments, the method can further comprise converting third party inputs into numerical parameters and evaluating at least one numerical output of the generated value function based on said numerical parameters prior to generating outputs transmitted to the third party.

In some embodiments, the method can further comprise, in response to third party authorization, communicating to both the user and the third party approval of the filled virtual template. The same can also be performed upon successful completion of a virtual negotiation.

The processing of third party entries either during a virtual negotiation and/or while filling out a virtual template (which may be performed simultaneously) can be performed, for instance, by using natural language processing to evaluate the inputs and convert them into input parameters or the like. To reply to the third party, standard predetermined responses may be used that can be prepared in advance and that may be comprised in a virtual negotiation flow (e.g. in different submodules of the virtual negotiation) and/or pulled from various databases as needed.

In a second embodiment, a system for generating a value function is disclosed. The system comprises a variable parameter database comprising variable parameters. The system further comprises an environmental parameter database comprising environmental parameters. The system also comprises a processing component. The processing component is configured to receive at least one variable parameter from the variable parameter database. It is also configured to receive at least one environmental parameter from the environmental parameter database. The processing component is further configured to define a relationship between the at least one input variable parameter and the at least one input environmental parameter. The processing component is also configured to generate a value function based at least in part on the input parameters and the defined relationship, the value function returning a real number.

The present system can be particularly configured to carry out the method according to the first embodiment of the invention. The system can also be preferably configured to carry out the method according to all the above method embodiments.

In some embodiments, the system can further comprise a user terminal configured to receive user feedback relating to the generated value function and transmit it to the processing component. The processing component can be further configured to update the generated value function by modifying at least one variable parameter.

In some embodiments, the environmental database can further comprise an auxiliary supporting data database. The processing component can then be further configured to convert auxiliary supporting data into at least one of a numerical input parameter and a constraint.

In some embodiments, the system can further comprise a negotiation interface configured to conduct a virtual negotiation. The negotiation interface can comprise, for example, a web-based chat interface. The processing component can be configured to use the generated value function as part of a virtual negotiation performed via the negotiation interface.

In such embodiments, the negotiation interface can be configured to establish communication at least between the processing component and a third party. The negotiation interface can also be configured to receive third party inputs. The negotiation interface can also be configured to transmit the third party inputs to the processing component.

In such embodiments, the processing component can be configured to estimate a third party value function based on the third party inputs. The processing component can be further configured to iteratively update the estimated third party value function based on further third-party inputs. The processing component can also be further configured to simultaneously optimize the generated value function and the estimated third-party value function. The simultaneous optimization can comprise optimization of a plurality of variable parameters associated with each of the two value functions.

In some embodiments, the processing component can be further configured to automatically trigger the virtual negotiation based on a predetermined threshold.

In some embodiments, the system can further comprise a template generating module configured to generate a virtual template.

The present invention is also defined by the following numbered embodiments.

Below is a list of method embodiments. Those will be indicated with a letter “M”. Whenever such embodiments are referred to, this will be done by referring to “M” embodiments.

M1. A method for generating and using a value function for a user, the method comprising
Inputting at least one variable parameter;
Inputting at least one environmental parameter;

Defining a relationship between the at least one input variable parameter and the at least one input environmental parameter;

Generating a value function based at least in part on the input parameters and the defined relationship, the value function returning a real number.

Embodiments Related to the Generation of the Value Function

M2. The method according to the preceding embodiment, wherein the value function is generated at least in part by combining the plurality of input parameters.

M3. The method according to any of the preceding embodiments, wherein the value function is generated at least in part by assigning dependencies to the input parameters.

M4. The method according to any of the preceding embodiments, wherein the value function is generated at least in part by creating a flowchart comprising steps for verifying the plurality of input parameters.

M5. The method according to any of the preceding embodiments, wherein the value function is generated at least in part by converting the plurality of input parameters into quantitative parameters.

M6. The method according to any of the preceding embodiments, wherein the value function is generated at least in part by applying a series of constraints to the input parameters.

M7. The method according to any of the preceding embodiments further comprising inputting auxiliary supporting data prior to generating the value function.

M8. The method according the preceding embodiment, further comprising converting auxiliary supporting data into at least one of a numerical input parameter and a constraint.

M9. The method according to any of the preceding embodiments further comprising updating the generated value function based on at least one of

new input parameter and

new auxiliary supporting data.

M10. The method according to any of the preceding embodiments further comprising forecasting time development of the generated value function by analyzing at least one of the environmental parameters.

M11. The method according to any of the preceding embodiments further comprising, in response to receiving user feedback, updating the generated value function by modifying at least one relationship between the at least one variable parameter and environmental parameter.

Embodiments Related to Generating a Virtual Template

M12. The method according to any of the preceding embodiments further comprising using at least one of the variable parameters to generate a virtual template for a user.

M13. The method according to the preceding embodiment wherein the virtual template comprises at least one of the variable parameters and at least one descriptive variable.

M14. The method according to any of the two preceding embodiments further comprising evaluating the value function based on the filled variable parameters of the virtual template.

M15. The method according to the preceding embodiment further comprising comparing a plurality of filled virtual templates by evaluating the value function based on the filled variable parameters of each virtual template.

M16. The method according to any of the four preceding embodiments further comprising using at least one of the environmental parameters to generate the virtual template and evaluating the value function based on the filled environmental parameters of the virtual template.

Embodiments Related to Using the Value Function in a Negotiation

M17. The method according to any of the preceding embodiments further comprising using the generated value function to conduct a virtual negotiation.

M18. The method according to the preceding embodiment further comprising communicating with a third party on behalf of the user.

M19. The method according to the preceding embodiment further comprising receiving third party inputs and estimating a third party value function based on them.

M20. The method according to the preceding embodiment further comprising iteratively updating the estimated third party value function based on further third-party inputs.

M21. The method according to any of the two preceding embodiments further comprising simultaneously optimizing against the generated value function and the estimated third party value function.

M22. The method according to the preceding embodiment wherein the simultaneous optimization comprises optimization of a plurality of variable parameters associated with each of the two value functions.

M23. The method according to any of the six preceding embodiments further comprising automatically triggering the virtual negotiation based on a predetermined threshold.

M24. The method according to any of the seven preceding embodiments further comprising building up a virtual negotiation by selecting predetermined negotiation submodules.

M25. The method according to the preceding embodiment wherein the selection is performed by evaluating a third party input in the virtual negotiation against the generated value function.

M26. The method according to any of the nine preceding embodiments and with features of embodiment M12 further comprising filling out the virtual template during the virtual negotiation.

M27. The method according to the preceding embodiment wherein the virtual template is filled based on third party input in the virtual negotiation evaluated against the generated value function.

Embodiments Related to Filling of a Virtual Template between a User and a Third Party

M28. The method according to any of the preceding embodiments further comprising filling out a virtual template associated with the user and a third party based at least in part on the generated value function.

M29. The method according to the preceding embodiment wherein the virtual template is filled automatically.

M30. The method according to any of the two preceding embodiments wherein the virtual template is user-dependent.

M31. The method according to any of the three preceding embodiments wherein the virtual template is third-party dependent.

M32. The method according to any of the four preceding embodiments wherein the virtual template is filled out at least in part based on third party inputs.

M33. The method according to the preceding embodiment further comprising receiving third party inputs and processing them to generate outputs transmitted to the third party.

M34. The method according to any of the two preceding embodiments further comprising comparing third party inputs to the generated value function, and, based on the comparison, generating outputs transmitted to the third party.

M35. The method according to any of the three preceding embodiments further comprising converting third party inputs into numerical parameters and evaluating at least one numerical output of the generated value function based on said numerical parameters prior to generating outputs transmitted to the third party.

M36. The method according to any of the eight preceding embodiments further comprising, in response to third party authorization, communicating to both the user and the third party approval of the filled virtual template.

Below is a list of system embodiments. Those will be indicated with a letter “5”. Whenever such embodiments are referred to, this will be done by referring to “5” embodiments.

S1. A system for generating a value function, the system comprising
A variable parameter database comprising variable parameters;
An environmental parameter database comprising environmental parameters;
A processing component configured to

Receive at least one variable parameter from the variable parameter database;

Receive at least one environmental parameter from the environmental parameter database;

Define a relationship between the at least one input variable parameter and the at least one input environmental parameter; and

Generate a value function based at least in part on the input parameters and the defined relationship, the value function returning a real number.

S2. The system according to the preceding embodiment further comprising

a user terminal configured to receive user feedback relating to the generated value function and transmit it to the processing component; and

Wherein the processing component is further configured to update the generated value function by modifying at least one variable parameter.

S3. The system according to any of the preceding system embodiments wherein the environmental database further comprises

An auxiliary supporting data database; and

Wherein the processing component is further configured to convert auxiliary supporting data into at least one of a numerical input parameter and a constraint.

S4. The system according to any of the preceding system embodiments further comprising a negotiation interface configured to conduct a virtual negotiation.

S5. The system according to the preceding embodiment wherein the processing component is configured to use the generated value function as part of a virtual negotiation performed via the negotiation interface.

S6. The system according to any of the two preceding embodiments wherein the negotiation interface is configured to establish communication at least between the processing component and a third party.

S7. The system according to the preceding embodiment wherein the negotiation interface is configured to receive third party inputs.

S8. The system according to the preceding embodiment wherein the negotiation interface is configured to transmit the third party inputs to the processing component.

S9. The system according to the preceding embodiment wherein the processing component is configured to estimate a third party value function based on the third party inputs.

S10. The system according to the preceding embodiment wherein the processing component is further configured to iteratively update the estimated third party value function based on further third-party inputs.

S11. The system according to any of the two preceding embodiments wherein the processing component is further configured to simultaneously optimize the generated value function and the estimated third-party value function.

S12. The system according to the preceding embodiment wherein the simultaneous optimization comprises optimization of a plurality of variable parameters associated with each of the two value functions.

S13. The method according to any of the ten preceding embodiments wherein the processing component is further configured to automatically trigger the virtual negotiation based on a predetermined threshold.

S14. The system according to any of the preceding system embodiments further comprising a template generating module configured to generate a virtual template.

S15. The system according to any of the preceding system embodiments configured to carry out the method according to any of the preceding method embodiments.

The present technology will now be discussed with reference to the accompanying drawings.

### BRIEF DESCRIPTION OF THE DRAWINGS

FIG. 1 depicts an embodiment of a method for generating a value function according to one aspect of the invention;

FIG. 2 depicts another embodiment of a method including using the value function according to one aspect of the invention;

FIG. 3 depicts an embodiment of a system with some optional components according to one embodiment of the invention;

FIG. 4 schematically depicts an embodiment of a system including different layers and structures according to one aspect of the invention;

FIG. 5 depicts an exemplary embodiment of a user interface according to one aspect of the invention;

FIG. 6 schematically depicts and embodiment of a virtual negotiation according to one aspect of the invention

FIG. 7 depicts an embodiment of a negotiation interface according to one aspect of the invention.

### DESCRIPTION OF EMBODIMENTS

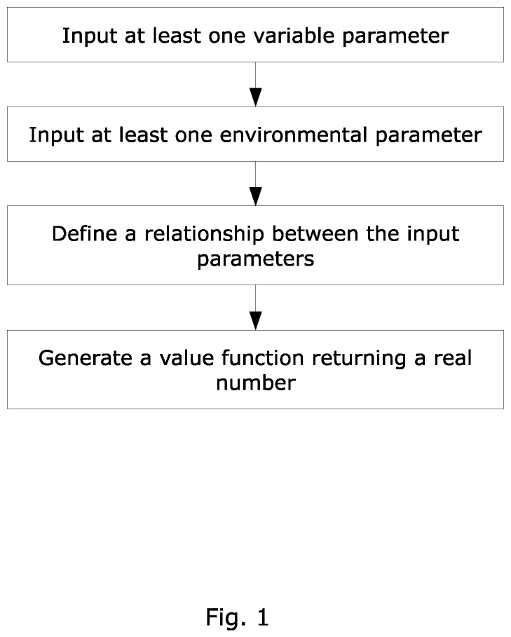

FIG. 1 schematically depicts an embodiment of a method for generating a value function. The method comprises inputting at least one variable and one environmental parameter. The parameters may be stored in databases, such as separate variable parameter and environmental parameter databases. The parameters may be input to a processing component that can comprise a server, a collection of servers or the like. The word “input” may also refer to the processing component accessing the parameters in the respective databases and extracting them.

The variable and environmental parameters may correspond to user-associated parameters. In one concrete example, a user may correspond to a company that is interested in automating contract negotiations. The variable and environmental parameters may correspond to historical and current data on various fees or transactions that the company has paid or performed. Further, the parameters may correspond to resources such as monetary, time or the like, geographical limitations or region-specific value assessments or the like.

The variable parameters generally reflect parameters associated with the user that can be varied depending on a situation. More specifically, variable parameters may reflect terms of a contract or an agreement that are not fixed, but can be negotiated. For example, variable parameters may comprise “amount of compensation”, “percentage of revenue”, “exclusive rights to a particular product” or the like.

The environmental parameters can generally reflect parameters that are fixed or not easily varied. For example, such parameters may comprise “total revenue in a region in a month”, “past number of licensing agreements”, “typical salary for a given position” or the like. These parameters may also reflect terms from existing contracts with various third parties or partners that are in force. Furthermore, the environmental parameters may also comprise parameters related to various partners or third parties that are known (such as “yearly revenue”, “number of employees” or the like). The environmental parameters may also comprise market conditions such as “inflation in a region”, “historical market gains” or the like.

Once the variable and environmental parameters are input, a relationship is defined between them. In other words, there is a dependency established between at least some of the input variables. Such dependency may be a functional relationship, a constraint, or the like. For example, if one variable parameter comprises “amount of compensation”, and one environmental parameter comprises “average salary in a given region”, the established relationship between the two may be “amount of compensation” is between half and thrice of an “average salary in a given region”. The relationship between the variables may be established pairwise or not. Furthermore, multiple relationships may be established between multiple input parameters, and relationships may be established between two or more variable parameters, one or more variable and one or more environmental parameters and/or one or more environmental parameters.

The method then comprises generating a value function that returns a real number. In other words, the value function may have a plurality of inputs some of which may be variable and some of which may be fixed, and some of the inputs may be interdependent. The output of the value function generally comprises, however, a real number. This allows for easy comparison between two different outputs of the value function based on different input parameters. The value function can be generated based at least in part on the input parameters and the defined relationship between them.

The value function can generally correspond to an explicit and preferably numerical representation of a user's priorities and interests as they relate to negotiations. The variable and environmental variables can relate to specific variable parts of contracts that the user is generally entering into. For example, some further variable parameter can comprise “percentage of revenue given as part of a license fee”, “percentage of transactions cancelled”, or “cost for exclusivity for selling a particular product”.

The parameters may be interrelated in a functional way and may affect the overall value of the value function as they are varied. For example, the above two mentioned exemplary parameters may be dependent, so that “cost for exclusivity” decreases with increased “percentage of revenue”. The relationship may be linear or otherwise, and can be determined as part of generating the value function.

Once the value function for a user is generated, it can be used as a backbone for automatically negotiating on behalf of the user. The processing component conducting the negotiation may then evaluate possible offers or contract terms against the value function to quantifiably determine the worth of a certain contract term (corresponding to variable parameters).

The present method allows to quantify user values in a concrete entity of the value function. In this way, value alignment of a user can be captured and used to optimize use of resources, save time and simplify complex processes that the user may be engaged in.

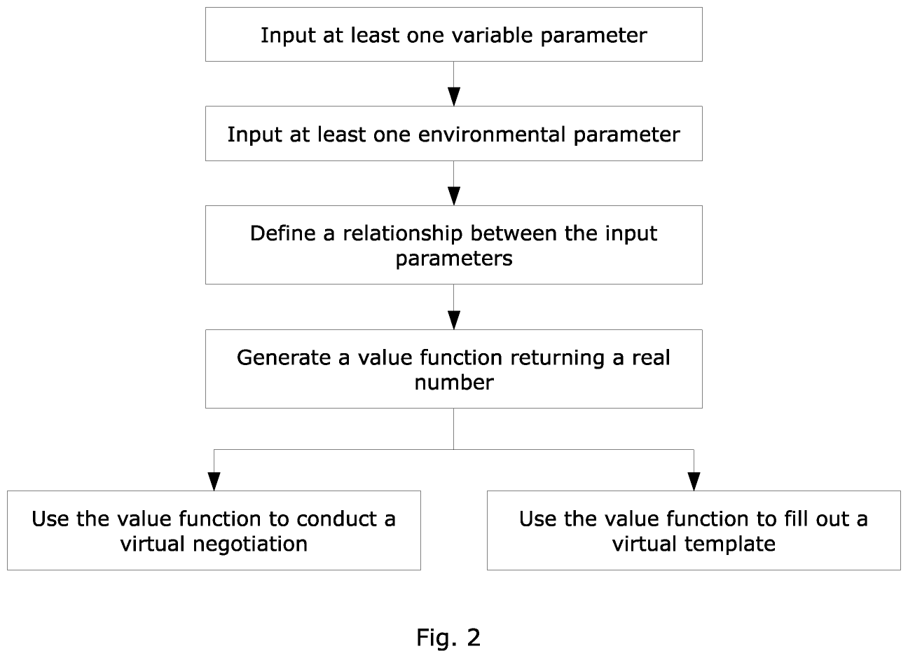

FIG. 2 depicts another embodiment of a method for generating and using a value function. The first four steps correspond to those of FIG. 1. Following the generating of the value function, it can then be used to conduct a virtual negotiation between a user and a third party (with the user represented by a processing component using the generated value function). That is, while negotiating different terms with the third party, the processing component conducting the negotiation may compare the resulting benefits or detriments based on the value function and particularly on the user-tailored variables. In this way, the specific effect of each negotiable term (corresponding to variable parameter) can be evaluated based on its effect on the value function. Note, that the third party may also be referred to as “partner” or “partner of a user”.

The value function can be further used to fill out a virtual template. The virtual template can correspond to a contract. The virtual contract can be generated independently of the value function, but can comprise some or all of the variable parameters also input into the value function. There may be a plurality of different virtual template that can be used by a user for different situations or as part of a contract with different partners or third parties. Filling out the template can be done as part of conducting the virtual negotiation. The processing component may evaluate responses of a third party negotiating with the user, and, based on those responses, gradually arrive at a filled virtual template that can correspond to an optimal contract for both parties.

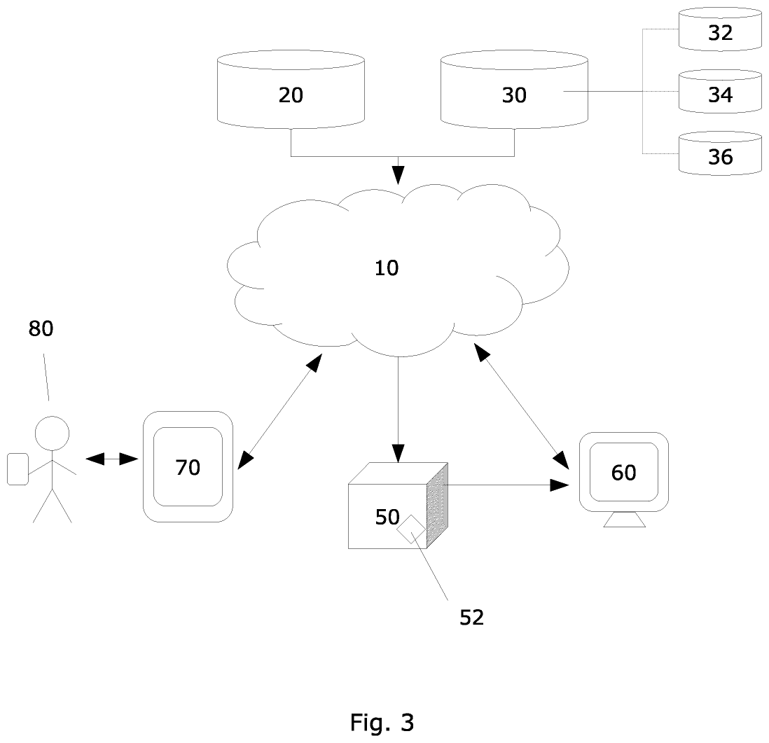

FIG. 3 schematically depicts an embodiment of a system for generating and using a value function. Some components of the system are optional.

Processing component 10 can correspond to a server, a collection of servers, a virtual server or the like. The processing component 10 can generally perform all computations and coordinate the functioning of the system.

Variable parameter database 20 may comprise variable parameters, specifically related to the user. For example, the database 20 may comprise parameters such as “licensing fee for an exclusive use of a product”.

Environmental parameter database 30 may comprise various environmental parameters that may be related to the user, to various third parties (partners) associated with the user and/or to auxiliary data.

Sub-databases 32, 34 and 36 reflect different types of environmental parameters that may be stored in the environmental parameter database 30. User state database 32 may store data related to current and/or past contract terms that the user has entered into. For example, such data may be related to past contract terms that the user preferred, such as e.g. between 5% and 10% license fee for exclusive use of a product.

Third party state database 34 may comprise data related to past transactions, agreements and/or contracts that various third parties have entered into, as well as various fixed parameters that may be associated with the third parties. For example, size, revenue, regional distribution of third parties or the like may be stored in third party state database 34. When using the value function 50 as part of a virtual negotiation with a third party or to fill a virtual template with a third party, it can be particularly advantageous to compare the third party in question to other similar third parties and contract terms that were agreed with them. Therefore, benchmarking by known and/or past data associated with various similar third parties can be useful as part of understanding the needs and values of a specific third party. The similarity may be established regionally, based on a business model or the like.

Auxiliary database 36 may comprise data related to general market situation, specific geographic or geopolitical data or the like.

The processing component 10 may have free access to the databases 20, 30 (and the respective sub-databases 32, 34, 36) to receive (and/or extract) the corresponding parameters.

Based on the extracted parameters and optionally other data, the processing component 10 can generate the value function 50. The value function 50 can correspond to a virtual object with a plurality of variable parameters 52.

User terminal 60 may be used to review the generated value function 50 and give feedback on it. This feedback can then be taken into account by the processing component 10 in order to modify the value function 50 to align more closely with the user's values.

Negotiation interface 70 may be in communication with the processing component 10 and a third party 80. The negotiation interface 70 can be used to conduct a virtual negotiation by the processing component 10. The processing component 10 may then evaluate possible outcomes of the negotiation against the value function 50 and conduct the negotiation based on such hypothetical results.

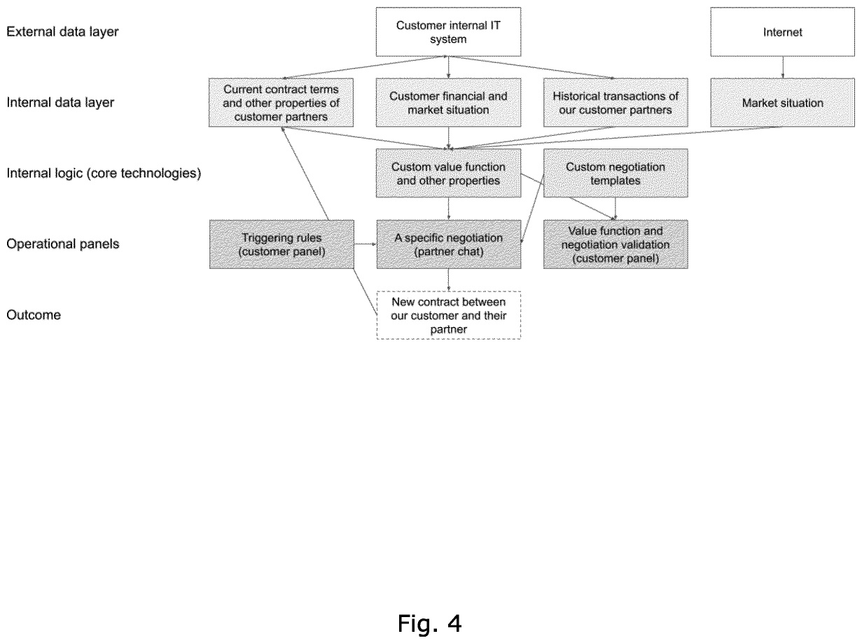

FIG. 4 depicts a schematic embodiment of a system for generating and using the value function including data structures and layers.

The external data layer may comprise the user's (customer's) own internal IT system and the internet as a source of additional data.

The internal data layer may comprise current contract terms, customer financial and market situation (together corresponding to current parameter database), historical transactions of customer partners (third parties during negotiation) corresponding at least in part to historical parameter database and market situation (derivable from outside sources such as the internet and corresponding to auxiliary parameter database).

The internal logic may comprise generating a custom user value function and custom negotiation templates which can be employed as part of a virtual negotiation.

The operation panels may allow rule triggering, conducting a particular negotiation and validating the generated value function (as part of a feedback loop).

The outcome of running the system can then comprise a newly negotiated contract between a user and a third party that mutually benefits both.

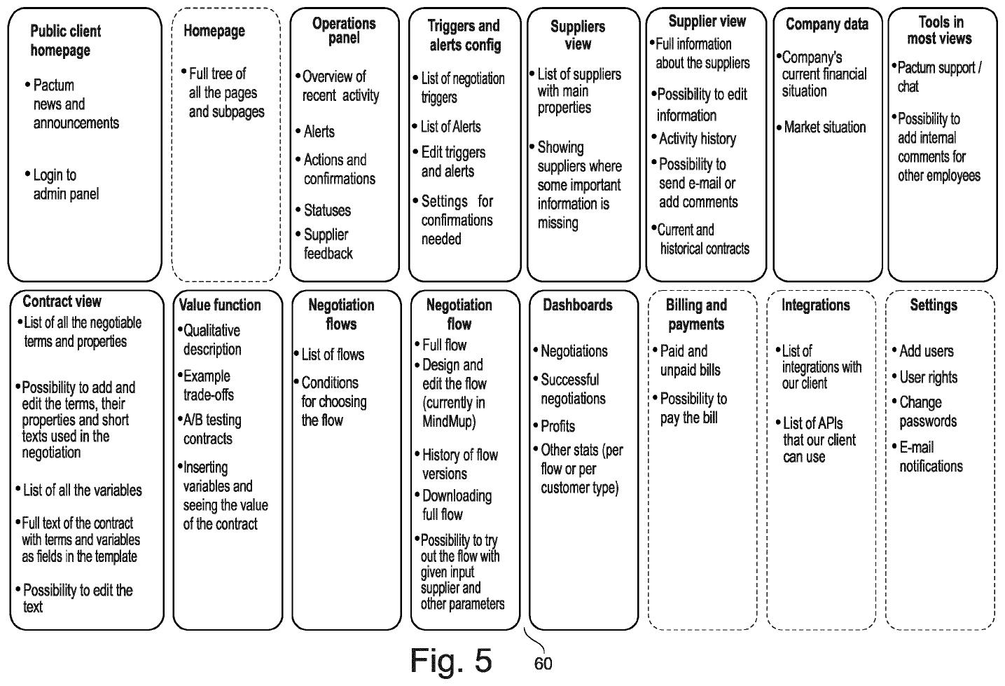

FIG. 5 schematically depicts an exemplary user terminal or user interface. The user may access the value function and give feedback on it, as well as provide triggers for e.g. automatically triggering a negotiation with a certain partner.

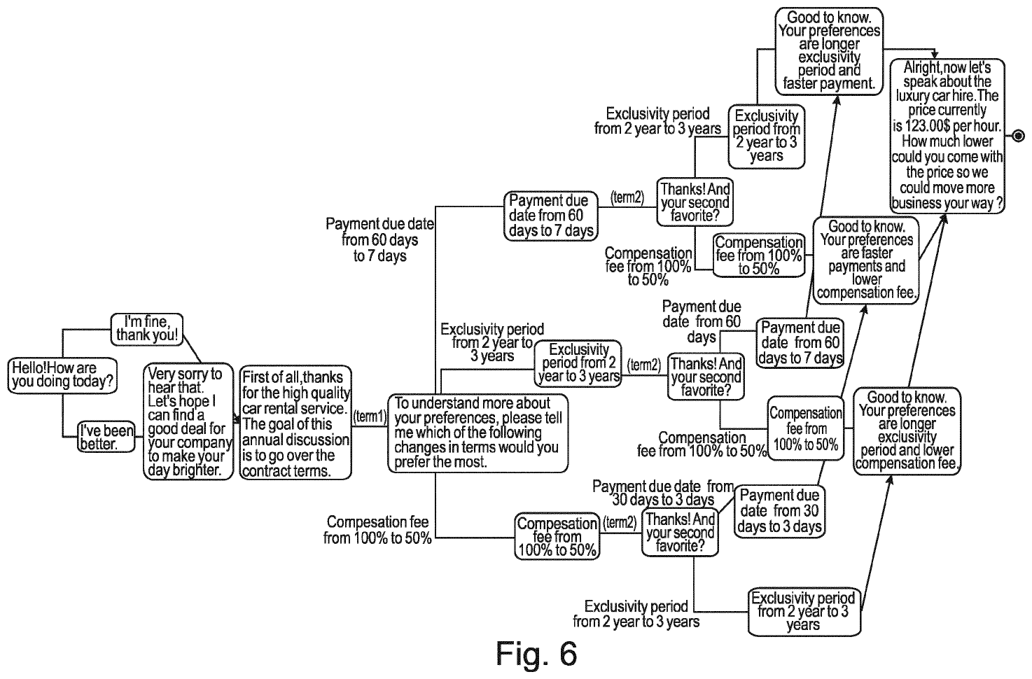

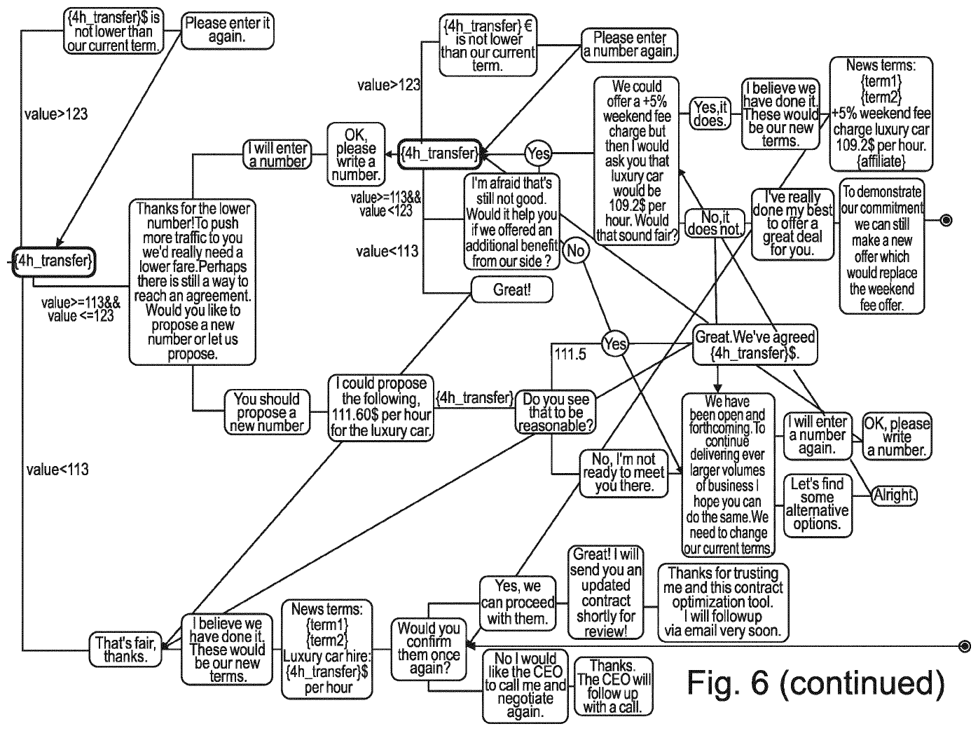

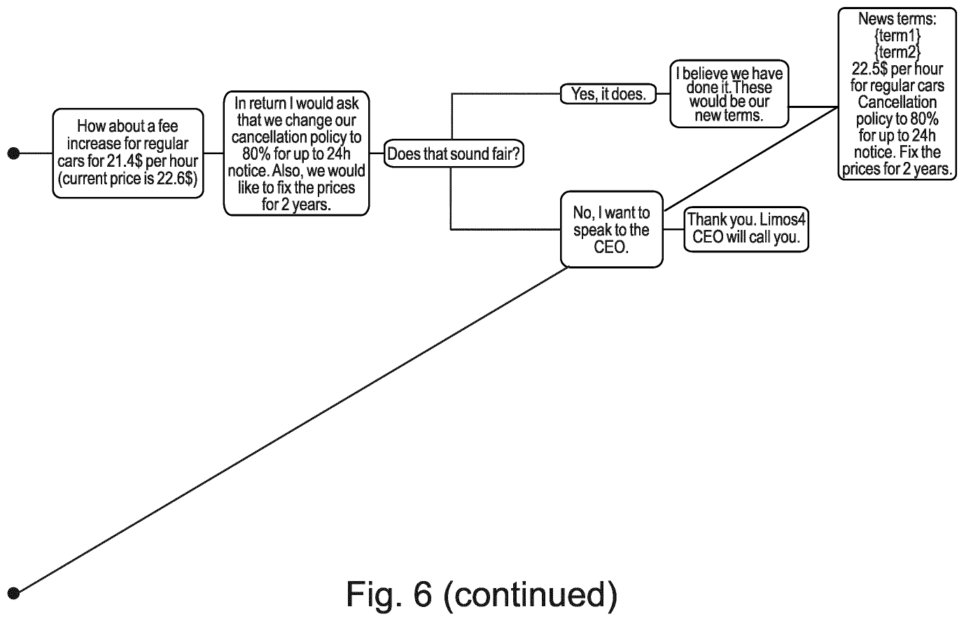

FIG. 6 schematically depicts an exemplary virtual negotiation. White text boxes correspond to prompts automatically sent to a third party, and grey text boxes correspond to third parties' replies. Next steps or layers in the negotiation are determined by the previous replies of the third party, so that the negotiation progresses based on all of the previous input. The blue boxes (lighter gray) may correspond to nodes where a specific numerical value is to be entered by the third party participating in the virtual negotiation. Additionally or alternatively, the third party may enter alphanumerical strings that can be processed using natural language processing and converted into variables such as variable parameters.

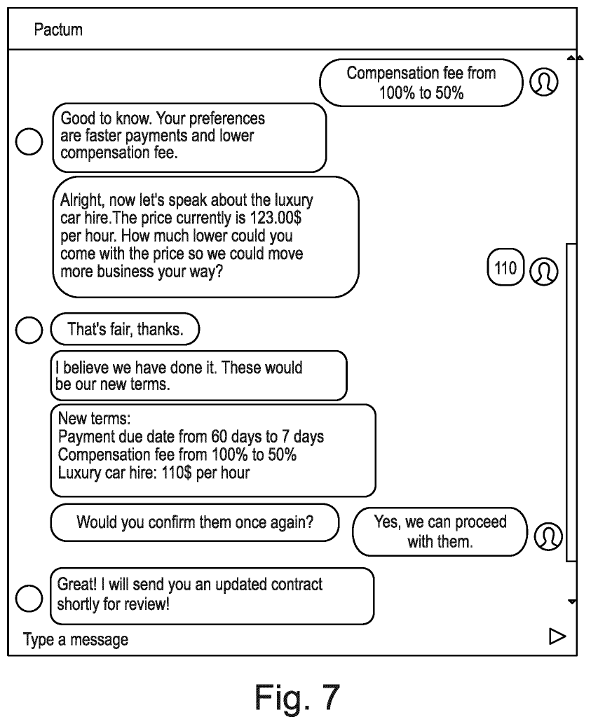

FIG. 7 schematically depicts an embodiment of a negotiation interface. The interface can correspond to a chat where the third party can type in their entries, and a processing component analyses them, and provides appropriate replies.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be the preferred order, but it may not be mandatory to carry out the steps in the recited order. That is, unless otherwise specified or unless clear to the skilled person, the order in which steps are recited may not be mandatory. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

1. A method for generating and using a value function for a user, the method comprising:
inputting at least one variable parameter;
inputting at least one environmental parameter;
defining a relationship between the at least one input variable parameter and the at least one input environmental parameter; and
generating a value function based at least in part on the input parameters and the defined relationship, the value function returning a real number.

2. The method according to claim 1, wherein the value function is generated at least in part by combining the plurality of input parameters and by assigning dependencies to the input parameters.

3. The method according to claim 1, wherein the value function is generated at least in part by applying a series of constraints to the input parameters.

4. The method according to claim 1 further comprising forecasting time development of the generated value function by analyzing at least one of the environmental parameters.

5. The method according to claim 1, further comprising, in response to receiving user feedback, updating the generated value function by modifying at least one relationship between the at least one variable parameter and environmental parameter.

6. The method according to claim 1, further comprising:
using at least one of the variable parameters to generate a virtual template for a user;
evaluating the value function based on the filled variable parameters of the virtual template; and
comparing a plurality of virtual templates by evaluating the value function based on the filled variable parameters of each virtual template.

7. The method according to claim 1, further comprising using the generated value function to conduct a virtual negotiation by communicating with a third party on behalf of the user, receiving third party inputs and estimating a third party value function based on them.

8. The method according to claim 7 further comprising iteratively updating the estimated third party value function based on further third-party inputs.

9. The method according to claim 7, further comprising simultaneously optimizing against the generated value function and the estimated third party value function.

10. The method according to claim 7, further comprising automatically triggering the virtual negotiation based on a predetermined threshold.

11. The method according to claim 1, further comprising building up a virtual negotiation by selecting predetermined negotiation submodules and wherein the selection is performed by evaluating a third party input in the virtual negotiation against the generated value function.

12. The method according to claim 6 further comprising filling out the virtual template during the virtual negotiation, wherein the virtual template is filled based on third party input in the virtual negotiation evaluated against the generated value function.

13. A system for generating a value function, the system comprising:
a variable parameter database comprising variable parameters;
an environmental parameter database comprising environmental parameters; and
a processing component configured to:
receive at least one variable parameter from the variable parameter database;
receive at least one environmental parameter from the environmental parameter database;
define a relationship between the at least one input variable parameter and the at least one input environmental parameter; and
generate a value function based at least in part on the input parameters and the defined relationship, the value function returning a real number.

14. The system according to claim 13, further comprising:
a user terminal configured to receive user feedback relating to the generated value function and transmit it to the processing component;
wherein the processing component is further configured to update the generated value function by modifying at least one variable parameter.

15. The system according to claim 13, further comprising a negotiation interface configured to conduct a virtual negotiation and wherein the processing component is configured to use the generated value function as part of a virtual negotiation performed via the negotiation interface.

16. The system according to claim 15, wherein the negotiation interface is configured to establish communication at least between the processing component and a third party, to receive third party inputs, and to transmit the third party inputs to the processing component.

17. The system according to claim 16, wherein the processing component is configured to estimate a third party value function based on the third party inputs, to iteratively update the estimated third party value function based on further third-party inputs and to simultaneously optimize the generated value function and the estimated third-party value function.
